(19) United States
(12) Patent Application Publication
(10) Pub. No.: US 2013/0082813 A1
(43) Pub. Date: Apr. 4, 2013

(54) COIL PARTS

(71) Applicants: Sung Kwon WI, Seoul (KR); Young Seuck Yoo, Seoul (KR); Jeong Bok Kwak, Gyeonggi-do (KR); Yong Suk Kim, Gyeonggi-do (KR); Sang Moon Lee, Seoul (KR); Young Ghyu Ahn, Gyeonggi-do (KR)

(72) Inventors: Sung Kwon WI, Seoul (KR); Young Seuck Yoo, Seoul (KR); Jeong Bok Kwak, Gyeonggi-do (KR); Yong Suk Kim, Gyeonggi-do (KR); Sang Moon Lee, Seoul (KR); Young Ghyu Ahn, Gyeonggi-do (KR)

(21) Appl. No.: 13/620,960

(22) Filed: Sep. 15, 2012

(30) Foreign Application Priority Data
Sep. 30, 2011 (KR) 10-2011-0099791

(51) Int. Cl. H01F 5/00

(52) U.S. Cl. 336/200

(57) ABSTRACT

A coil part is provided. The coil part includes a coil layer, a lower magnetic layer, and an upper magnetic layer. The coil layer includes a primary coil pattern, a secondary coil pattern, and a dielectric including the primary coil pattern and the secondary coil pattern. The lower magnetic layer is disposed under the coil layer. The upper magnetic layer is disposed on the lower magnetic layer to fill up the center and the periphery of the coil layer and cover the coil layer. Accordingly, the coil part can improve filtering characteristics by more smoothly increasing a magnetic flux surrounding the coil pattern. Also, the coil part can cut fabrication costs by reducing the length of the coil pattern with respect to the same characteristics.

### CROSS-REFERENCE TO RELATED APPLICATIONS

This application claims the benefit of Korean Patent Application No. 10-2011-0099791 filed with the Korea Intellectual Property Office on Sep. 30, 2011, the disclosure of which is incorporated herein by reference.

### BACKGROUND OF THE INVENTION

1. Field of the Invention

The present invention relates to coil parts, and more particularly, to coil parts that can improve filtering characteristics by more smoothly increasing a magnetic flux around a coil pattern and can cut fabrication costs by reducing the length of the coil pattern with respect to the same characteristics.

2. Description of the Related Art

Electronic products, such as digital TVs, smart phones and notebook computers, have functions for data communication in radio-frequency (RF) bands. Such IT electronic products are expected to be more widely used because they have multifunctional and complex features by connecting not only one device but also USBs and other communication ports.

For higher-speed data communication, data are communicated through more internal signal lines over GHz RF channels higher than MHz channels.

When more data are communicated between a main device and a peripheral device over a GHz RF channel, it is difficult to provide smooth data processing due to a signal delay and other noises.

In order to solve the above problem, an electromagnetic interference (EMI) prevention part is provided around the connection between an IT device and a peripheral device. However, conventional EMI prevention parts are used only in limited fields such as large-area substrates because they are coil-type and stack-type and have large chip part sizes and poor electrical characteristics. What is therefore required is EMI prevention parts that are suitable for the slim, miniaturized, complex and multifunctional features of electronic products.

A common-mode filter of a conventional EMI prevention coil part is described below in detail with reference to FIG. 1.

Referring to FIG. 1, a conventional common-mode filter includes a first magnetic substrate 1, a dielectric layer 2 disposed on the magnetic substrate 1 and including a first coil pattern 2a and a second coil pattern 2b that are vertically symmetrical to each other, and a second magnetic substrate 3 disposed on the dielectric layer 2.

Herein, the dielectric layer 2 including the first coil pattern 2a and the second coil pattern 2b is formed on the first magnetic substrate 1 through a thin-film process. An example of the thin-film process is disclosed in Japanese Patent Application Laid-Open No. 8-203737.

The second magnetic substrate 3 is bonded to the dielectric layer 2 through an adhesive layer 4.

An external electrode 5 is disposed to surround both ends of a structure including the first magnetic substrate 1, the dielectric layer 2 and the second magnetic substrate 3. The external electrode 5 is electrically connected through a lead line (not shown) to the first coil pattern 2a and the second coil pattern 2b.

However, in the conventional common-mode filter, the non-magnetic characteristics of the dielectric layer 2 cause a minus effect that partially blocks a magnetic flux at the center and the periphery of the first coil pattern 2a and the second coil pattern 2b in the dielectric layer 2. Also, the non-magnetic dielectric layer 4 causes an increase in the magnetic resistance, thus further blocking the magnetic flux. This causes an increase in the insertion loss and a decrease in the common-mode impedance, thus degrading the filtering characteristics.

Also, since the second magnetic substrate 3 is bonded to the dielectric layer 2 through the adhesive layer 4, the magnetic flux is further blocked by the non-magnetic characteristics of the adhesive layer 4, thus causing the rapid characteristic degradation of the conventional common-mode filter.

The first coil pattern 2a and the second coil pattern 2b may be elongated to solve the above problems. This, however, increases the fabrication costs of the coil part and the size of the coil part.

### SUMMARY OF THE INVENTION

The present invention has been invented in order to overcome the above-described problems and it is, therefore, an object of the present invention to provide a coil part that can improve filtering characteristics by more smoothly increasing a magnetic flux surrounding a coil pattern.

It is another object of the present invention to provide a coil part that can cut fabrication costs by reducing the length of a coil pattern with respect to the same characteristics.

In accordance with one aspect of the present invention to achieve the object, there is provided a coil part, which comprises: a coil layer including a primary coil pattern, a secondary coil pattern, and a dielectric including the primary coil pattern and the secondary coil pattern; a lower magnetic layer disposed under the coil layer; and an upper magnetic layer disposed on the lower magnetic layer to fill up the center and the periphery of the coil layer and cover the coil layer.

The upper magnetic layer may include a resin and a ferrite.

The upper magnetic layer may be formed on the lower magnetic layer through a printing process or a coating process.

The lower magnetic layer may include a ceramic substrate including a ferrite.

The coil part may further include a reinforcing layer configured to reinforce a bonding force between the upper magnetic layer and the lower magnetic layer.

When the upper magnetic layer is bonded onto the lower magnetic layer, the reinforcing layer may be disposed on at least the bonding interface exposed to the outside.

The dielectric may be formed of a non-magnetic material.

The dielectric may include a polymer.

The dielectric may have a dielectric constant of about 3.5 or less and a magnetic permeability of about 1 or less.

The dielectric may have a thickness of about 35 μm.

In accordance with another aspect of the present invention to achieve the object, there is provided a coil part, which comprises: a dielectric including a primary coil pattern and a secondary coil pattern; a lower magnetic layer disposed under the dielectric; an upper magnetic layer disposed on the dielectric; and a magnetic flux reinforcement disposed at the center and the periphery of the dielectric.

The magnetic flux reinforcement may include a magnetic material and an adhesive material.

The upper magnetic layer and the lower magnetic layer may include a ceramic substrate including a ferrite.

The upper magnetic layer may further include a resin.

The coil part may further include a reinforcing layer configured to reinforce the bonding force between the upper magnetic layer and the lower magnetic layer.

When the upper magnetic layer is bonded onto the lower magnetic layer, the reinforcing layer may be disposed on at least the bonding interface exposed to the outside.

The dielectric may be formed of a non-magnetic material.

The dielectric may include a polymer.

The dielectric may have a dielectric constant of about 3.5 or less and a magnetic permeability of about 1 or less.

The dielectric may have a thickness of about 35 μm.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of a common-mode filter of a conventional coil part;

FIG. 2 is a cross-sectional view of a coil part in accordance with a first embodiment of the present invention;

FIG. 3 is a cross-sectional view of a coil part in accordance with a second embodiment of the present invention;

FIG. 4 is a sectional view taken along a line I-I′ of FIG. 3;

FIG. 5 is a graph showing the comparison between an insertion loss for the case of a magnetic flux reinforcement being disposed at the center of a dielectric and an insertion loss for the case of a magnetic flux reinforcement being disposed at the center and the periphery of a dielectric; and

FIG. 6 is a graph showing the comparison between the common-mode impedance values (Z_CM) of coil parts according to the thickness of a dielectric and the presence/absence of an adhesive.

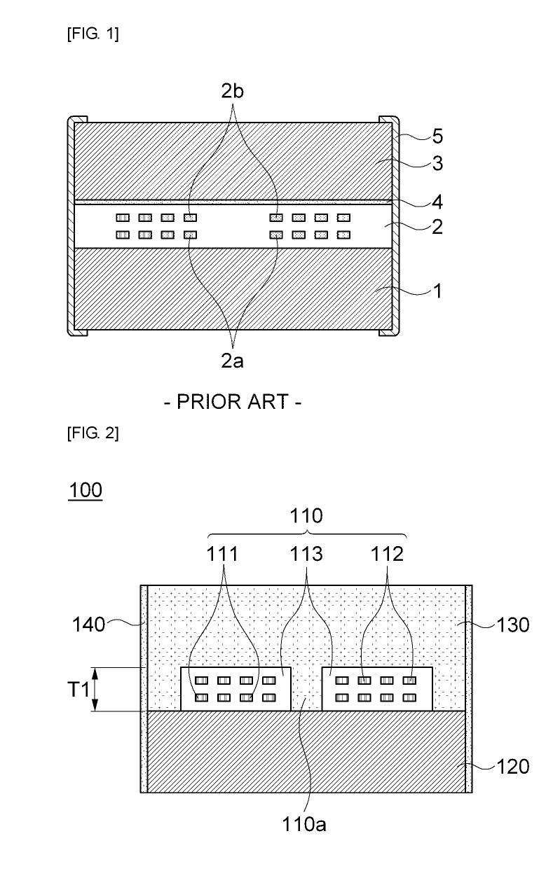

### DETAILED DESCRIPTION OF THE PREFERABLE EMBODIMENTS

Exemplary embodiments of the present invention will be described below in detail with reference to the accompanying drawings. Advantages and features of the inventive concept, and implementation methods thereof will be clarified through the following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Like reference numerals denote like elements throughout the specification and drawings.

The terms used herein are for the purpose of describing the exemplary embodiments only and are not intended to limit the scope of the present invention. As used herein, the singular forms ‘a’, ‘an’, and ‘the’ are intended to include the plural forms as well, unless the context clearly indicates otherwise. It will also be understood that the terms ‘comprise’, ‘include’ and ‘have’ used herein specify the presence of stated components, steps, operations, and/or elements, but do not preclude the presence or addition of one or more other components, steps, operations, and/or elements.

The embodiments of the present invention will be described with reference to cross-sectional views or plan views as ideal exemplary views of the present invention. In the drawings, the thicknesses or dimensions of layers and regions are exaggerated for effective description of technical features. Accordingly, shapes of the exemplary views may be modified according to manufacturing techniques and/or allowances. Therefore, the embodiments of the present invention are not limited to the specific shapes illustrated in the exemplary views, but may include other shapes that may be created according to manufacturing processes. For example, an etched region illustrated as a rectangle may have rounded or curved features. Thus, the regions illustrated in the drawings are schematic in nature, and their shapes are intended to exemplify the specific shapes of the regions of a device and are not intended to limit the scope of the present invention.

Coil parts in accordance with embodiments of the present invention will be described below in detail with reference to FIGS. 2 to 6.

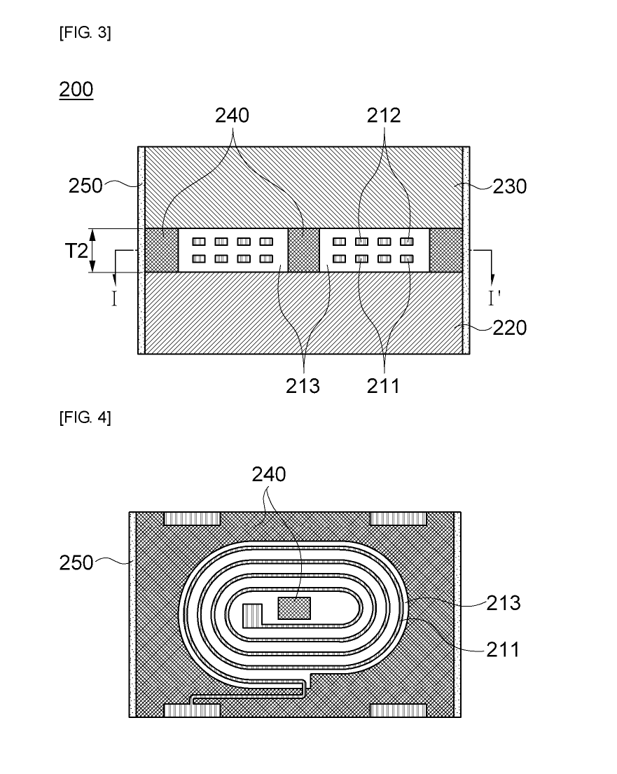

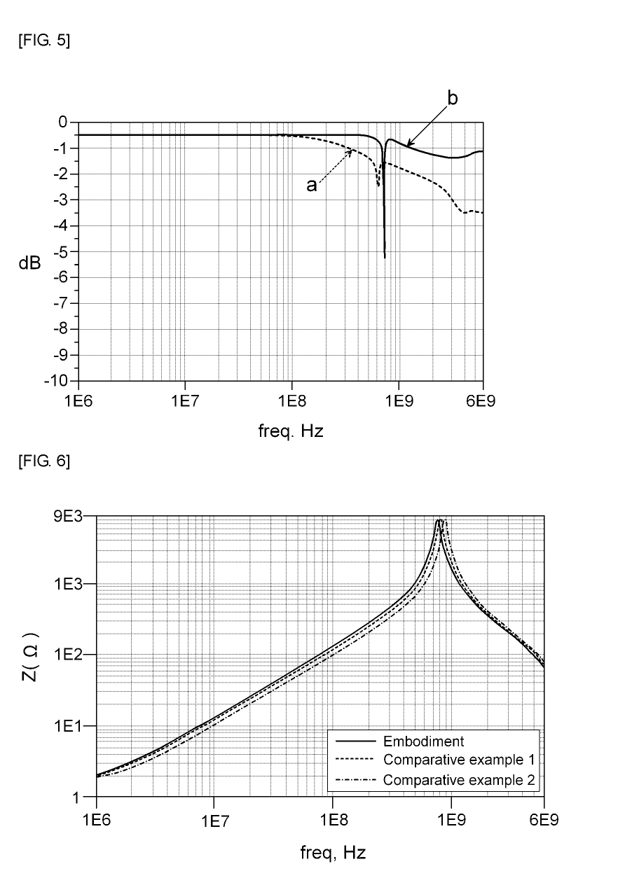

FIG. 2 is a cross-sectional view of a coil part in accordance with a first embodiment of the present invention. FIG. 3 is a cross-sectional view of a coil part in accordance with a second embodiment of the present invention. FIG. 4 is a sectional view taken along a line I-I′ of FIG. 3. FIG. 5 is a graph showing the comparison between an insertion loss for the case of a magnetic flux reinforcement being disposed at the center of a dielectric and an insertion loss for the case of a magnetic flux reinforcement being disposed at the center and the periphery of a dielectric. FIG. 6 is a graph showing the comparison between the common-mode impedance values (Z_CM) of coil parts according to the thickness of a dielectric and the presence/absence of an adhesive.

A coil part in accordance with a first embodiment of the present invention will be described below with reference to FIG. 2.

Referring to FIG. 2, a coil part 100 in accordance with a first embodiment of the present invention includes a coil layer 110; a lower magnetic layer 120 disposed under the coil layer 110; and an upper magnetic layer 130 disposed on the coil layer 110.

The coil layer 110 may include a primary coil pattern 111 formed on a horizontal plane in a spiral shape, a secondary coil pattern 112 formed on the primary coil pattern 111 in the shape corresponding to the primary coil pattern 111, and a dielectric 113 including the primary coil pattern 111 and the secondary coil pattern 112.

Herein, the dielectric 113 may be formed of a non-magnetic material.

The dielectric 113 may include a polymer. Accordingly, the dielectric 113 may have a dielectric constant of about 3.5 or less and a magnetic permeability of about 1 or less.

For common-mode impedance improvement and filtering characteristic improvement, the dielectric 113 may have a thickness of approximately 35 μm, which will be described below in detail in a second embodiment of the present invention.

The lower magnetic layer 120 may include a ceramic substrate formed of a ferrite material. The coil layer 110 may be formed on the lower magnetic layer 120 through a thin-film process.

The upper magnetic layer 130 may be formed on the lower magnetic layer 120 to fill up the center 110a and the periphery 110b of the coil layer 110 and cover the dielectric 113 of the coil layer 110.

The upper magnetic layer 130 may be formed to include a resin and a ferrite.

Accordingly, the upper magnetic layer 130 may be formed on the lower magnetic layer 120 through a printing process or a coating process.

That is, unlike in the conventional coil part, the upper magnetic layer 130 may be bonded onto the lower magnetic layer 120 without a separate adhesive layer.

Accordingly, the coil part 100 can more smoothly improve a magnetic flux by preventing the magnetic flux from being blocked by the conventional adhesive layer, thus making it possible to improve the filtering characteristics due to a decrease in the insertion loss and an increase in the common-mode impedance.

The coil part 100 may further include a reinforcing layer 140 to reinforce the bonding force between the upper magnetic layer 130 and the lower magnetic layer 120.

When the upper magnetic layer 130 is bonded onto the lower magnetic layer 120, the reinforcing layer 140 may be disposed on at least the bonding interface exposed to the outside.

A coil part in accordance with a second embodiment of the present invention will be described below with reference to FIGS. 3 to 6.

Referring to FIGS. 3 and 4, a coil part 200 in accordance with a second embodiment of the present invention includes a dielectric 213 including a primary coil pattern 211 and a secondary coil pattern 212; a lower magnetic layer 220 disposed under the dielectric 213; an upper magnetic layer 230 disposed on the dielectric 213; and a magnetic flux reinforcement 240 disposed at the center and the periphery of the dielectric 213.

Herein, the magnetic flux reinforcement 240 may be formed to include a magnetic material and an adhesive material. For example, the magnetic flux reinforcement 240 may be formed to include a ferrite and a photoresist (PR).

Accordingly, the upper magnetic layer 230 may be bonded by the magnetic flux reinforcement 240 onto the dielectric 213 without a separate adhesive layer.

Accordingly, the coil part 200 can more smoothly improve a magnetic flux by preventing the magnetic flux from being blocked by the conventional adhesive layer, thus making it possible to improve the filtering characteristics due to a decrease in the insertion loss and an increase in the common-mode impedance.

Specifically, because the coil part 200 has the magnetic flux reinforcement 240 formed to provide a passage for the magnetic flux, it can considerably reduce the insertion loss and increase the common-mode impedance, as compared to the case of not using the magnetic flux reinforcement.

Also, as can be seen from FIG. 5, because the coil part 200 has the magnetic flux reinforcement 240 disposed at the center and the periphery of the dielectric 213 (a curve ‘a’ in FIG. 5), it can considerably reduce the insertion loss and improve the filtering characteristics in RF bands, as compared to the case of providing the magnetic flux reinforcement only at the center of the dielectric (a curve ‘b’ in FIG. 5).

The upper magnetic layer 230 and the lower magnetic layer 220 may include a ceramic substrate including a ferrite.

The upper magnetic layer 230 may further include a resin to increase the bonding force with respect to the dielectric 213.

The coil part 200 may further include a reinforcing layer 250 to reinforce the bonding force between the upper magnetic layer 230 and the lower magnetic layer 220.

When the upper magnetic layer 230 is bonded onto the dielectric 213, the reinforcing layer 250 may be disposed on at least the bonding interface exposed to the outside. Also, the reinforcing layer 250 may extend to the bonding interface between the dielectric 213 and the lower magnetic layer 220.

The dielectric 213 may be formed of a non-magnetic material.

The dielectric 213 may include a polymer. Accordingly, the dielectric 213 may have a dielectric constant of about 3.5 or less and a magnetic permeability of about 1 or less.

For common-mode impedance improvement and filtering characteristic improvement, the dielectric 213 may have a thickness of approximately 35 μm.

Referring to FIG. 6 and Table 1, as a result of the experiment on impedance characteristics for the case of the dielectric having a thickness of about 40 μm (Comparative Example 1), the case of the dielectric having a thickness of about 45 μm, including the conventional adhesive layer (Comparative Example 2), and the case of the dielectric having a thickness of about 35 μm without a separate adhesive layer (Embodiment of the present invention), it can be seen that the differential-mode impedances (Z_DM) are similar in the comparative example 1, the comparative example 2 and the embodiment, but the common-mode mode impedance (Z_CM) in the embodiment is considerably increased as compared to those in the comparative examples 1 and 2.

TABLE 1

| | Comparative | | Comparative | | | |
|---|---|---|---|---|---|---|
| Classification | Example 1 | | Example 2 | | Embodiment | |
| Thickness of Dielectric | 40 | μm | 45 | μm | 35 | μm |
| Z_CM(@100 MHz) | 118.0 | Ω | 99.4 | Ω | 131.5 | Ω |
| Z_DM(@100 MHz) | 11.14 | Ω | 10.79 | Ω | 11.48 | Ω |

As described above, the coil parts according to the present invention can improve filtering characteristics by more smoothly increasing a magnetic flux surrounding a coil pattern.

Also, the coil parts according to the present invention can cut fabrication costs by reducing the length of a coil pattern with respect to the same characteristics.

Although the preferable embodiments of the present invention have been shown and described above, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A coil part, which comprises:
a coil layer including a primary coil pattern, a secondary coil pattern, and a dielectric including the primary coil pattern and the secondary coil pattern;
a lower magnetic layer disposed under the coil layer; and
an upper magnetic layer disposed on the lower magnetic layer to fill up the center and the periphery of the coil layer and cover the coil layer.

2. The coil part according to claim 1, wherein the upper magnetic layer includes a resin and a ferrite.

3. The coil part according to claim 1, wherein the upper magnetic layer is formed on the lower magnetic layer through a printing process or a coating process.

4. The coil part according to claim 1, wherein the lower magnetic layer includes a ceramic substrate including a ferrite.

5. The coil part according to claim 1, which further comprises a reinforcing layer configured to reinforce a bonding force between the upper magnetic layer and the lower magnetic layer.

6. The coil part according to claim 5, wherein when the upper magnetic layer is bonded onto the lower magnetic layer, the reinforcing layer is disposed on at least the bonding interface exposed to the outside.

7. The coil part according to claim 1, wherein the dielectric is formed of a non-magnetic material.

8. The coil part according to claim 7, wherein the dielectric includes a polymer.

9. The coil part according to claim 8, wherein the dielectric has a dielectric constant of about 3.5 or less and a magnetic permeability of about 1 or less.

10. The coil part according to claim 1, wherein the dielectric has a thickness of about 35 μm.

11. A coil part, which comprises:
a dielectric including a primary coil pattern and a secondary coil pattern;
a lower magnetic layer disposed under the dielectric;
an upper magnetic layer disposed on the dielectric; and
a magnetic flux reinforcement disposed at the center and the periphery of the dielectric.

12. The coil part according to claim 11, wherein the magnetic flux reinforcement includes a magnetic material and an adhesive material.

13. The coil part according to claim 11, wherein the upper magnetic layer and the lower magnetic layer include a ceramic substrate including a ferrite.

14. The coil part according to claim 13, wherein the upper magnetic layer further includes a resin.

15. The coil part according to claim 11, which further comprises a reinforcing layer configured to reinforce the bonding force between the upper magnetic layer and the lower magnetic layer.

16. The coil part according to claim 15, wherein when the upper magnetic layer is bonded onto the lower magnetic layer, the reinforcing layer is disposed on at least the bonding interface exposed to the outside.

17. The coil part according to claim 11, wherein the dielectric is formed of a non-magnetic material.

18. The coil part according to claim 17, wherein the dielectric includes a polymer.

19. The coil part according to claim 18, wherein the dielectric has a dielectric constant of about 3.5 or less and a magnetic permeability of about 1 or less.

20. The coil part according to claim 11, wherein the dielectric has a thickness of about 35 μm.
